(19) United States
(12) Patent Application Publication
(10) Pub. No.: US 2026/0169417 A1
(43) Pub. Date: Jun. 18, 2026

(54) SHEET DISCHARGE APPARATUS AND IMAGE FORMING APPARATUS

(71) Applicant: CANON KABUSHIKI KAISHA, Tokyo (JP)

(72) Inventors: YOSHISUKE KASUYA, Shizuoka (JP); HIROSHI KAWAGUCHI, Shizuoka (JP); SACHIYORI SHIINA, Shizuoka (JP)

(21) Appl. No.: 19/407,691

(22) Filed: Dec. 3, 2025

(30) Foreign Application Priority Data
Dec. 17, 2024 (JP) 2024-221171

(51) Int. Cl. G03G 15/00; G03G 21/16

(52) U.S. Cl. CPC G03G 15/6552; G03G 21/1633

(57) ABSTRACT

A sheet discharge apparatus includes a housing including an upper surface portion including a first surface and a second surface, a first extension tray including a third surface, a second extension tray including a fourth surface and an interlocking portion, and a discharge roller. In a state in which the first extension tray is at the first use position, at least a part of the third surface is positioned downstream of the first surface in the sheet discharge direction. In a state in which the second extension tray is at the second use position, at least a part of the fourth surface is positioned downstream of the third surface in the sheet discharge direction. At least a part of the third surface moves upward when the first extension tray moves from the first retracted position to the first use position.

### BACKGROUND

### Field of the Technology

The present disclosure relates to a sheet discharge apparatus that discharges a sheet, and an image forming apparatus that forms an image on the sheet.

### Description of the Related Art

Japanese Patent Laid-open No. 2007-328302 A discloses an image forming apparatus including a sheet discharge tray formed on an upper surface of a printer body and an extension tray that is disposed downstream of the sheet discharge tray and supports a sheet together with the sheet discharge tray in a pulled-out state.

### SUMMARY

The present disclosure provides a sheet discharge apparatus and an image forming apparatus capable of improving alignment of discharged sheets.

An aspect of the present disclosure provides a sheet discharge apparatus including a housing including an upper surface portion and a discharge opening through which a sheet discharged in a sheet discharge direction passes, the upper surface portion including a first surface that is inclined upward while extending downstream in the sheet discharge direction and a second surface that is provided downstream of the first surface in the sheet discharge direction, the first surface and the second surface being configured to receive the sheet discharged from the discharge opening, an angle between the second surface and a horizontal plane being smaller than an angle between the first surface and the horizontal plane, a first extension tray including a third surface, disposed at the upper surface portion, and configured to move between a first retracted position and a first use position, a second extension tray including a fourth surface and an interlocking portion, disposed at the upper surface portion, and configured to be pivoted between a second retracted position and a second use position, the interlocking portion being configured to move the first extension tray from the first retracted position to the first use position when the second extension tray is pivoted from the second retracted position to the second use position, and a discharge roller configured to discharge the sheet through the discharge opening and convey the sheet to a position where the sheet comes into contact with the third surface and the fourth surface in a state in which the first extension tray is at the first use position and the second extension tray is at the second use position, wherein in a state in which the first extension tray is at the first use position, at least a part of the third surface is positioned downstream of the first surface in the sheet discharge direction, is positioned above the second surface, and is inclined upward while extending downstream in the sheet discharge direction, in a state in which the second extension tray is at the second use position, at least a part of the fourth surface is positioned downstream of the third surface in the sheet discharge direction, is positioned above the second surface and the third surface, and is inclined upward while extending downstream in the sheet discharge direction, and at least a part of the third surface moves upward when the first extension tray moves from the first retracted position to the first use position.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view illustrating an image forming apparatus according to a first embodiment.

FIG. 2A is a perspective view illustrating a housed state of a first extension tray and a second extension tray according to the first embodiment.

FIG. 2B is a cross-sectional view illustrating the housed state of the first extension tray and the second extension tray according to the first embodiment.

FIG. 3A is a perspective view illustrating an extended state of the first extension tray and the second extension tray according to the first embodiment.

FIG. 3B is a cross-sectional view illustrating the extended state of the first extension tray and the second extension tray according to the first embodiment.

FIG. 4A is an explanatory view of the second extension tray according to the first embodiment.

FIG. 4B is an explanatory view of the second extension tray according to the first embodiment.

FIG. 5A is an explanatory view of the first extension tray according to the first embodiment.

FIG. 5B is an explanatory view of the first extension tray according to the first embodiment.

FIG. 6A is a perspective view illustrating a housed state of a first extension tray and a second extension tray according to a second embodiment.

FIG. 6B is a cross-sectional view illustrating the housed state of the first extension tray and the second extension tray according to the second embodiment.

FIG. 7A is a perspective view illustrating an extended state of the first extension tray and the second extension tray according to the second embodiment.

FIG. 7B is a cross-sectional view illustrating the extended state of the first extension tray and the second extension tray according to the second embodiment.

FIG. 8A is an explanatory view of the first extension tray and the second extension tray according to the second embodiment.

FIG. 8B is an explanatory view of the first extension tray and the second extension tray according to the second embodiment.

FIG. 8C is an explanatory view of the first extension tray and the second extension tray according to the second embodiment.

### DESCRIPTION OF THE EMBODIMENTS

Hereinafter, embodiments according to the present disclosure will be described with reference to the drawings.

### First Embodiment

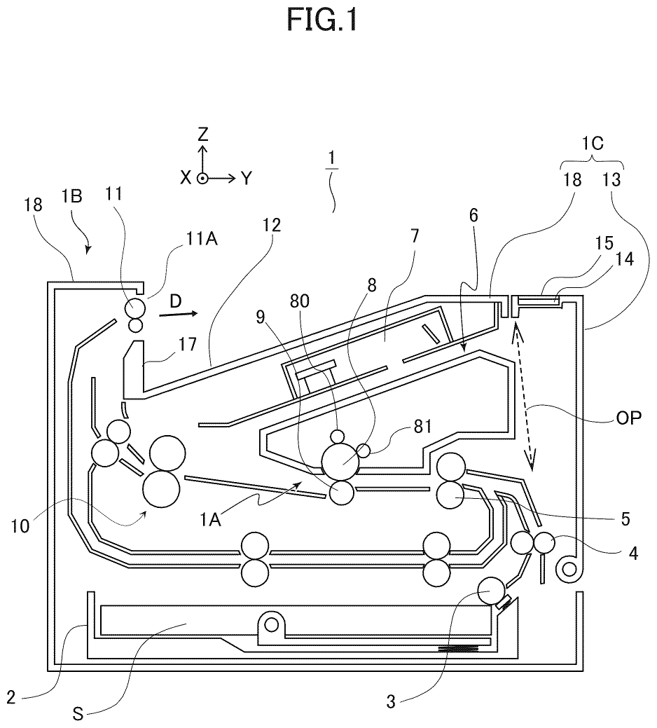

FIG. 1 is a cross-sectional view illustrating an image forming apparatus 1 according to an embodiment (first embodiment) of the present disclosure. The image forming apparatus 1 is an image forming apparatus that forms an image on a sheet S by an electrophotographic process according to image information sent from external equipment such as a computer communicably connected to the image forming apparatus 1.

In the present disclosure, the “image forming apparatus” refers to a general apparatus having a function of forming an image on a sheet which is a recording material (recording medium). The image forming apparatus may be a single-function printer, a copier, or a multifunction peripheral. The image forming apparatus may be an apparatus that mainly forms a color image or may be an apparatus that mainly forms a monochrome image. Furthermore, the image forming apparatus may be a system (image forming system) in which a main body of the image forming apparatus that forms an image on a recording material and accessory equipment used together with the main body of the image forming apparatus body are connected to each other. Examples of the accessory equipment include a sheet processing apparatus (finisher) that performs processing such as binding processing on a sheet on which an image is formed, a conveyance apparatus that conveys a sheet from the main body of the image forming apparatus body to another apparatus, and a feeding device (option feeder) that feeds a sheet toward the main body of the image forming apparatus body. As the sheet S serving as the recording material (recording medium), various sheet materials having different sizes and materials, for example, paper such as plain paper or thick paper, a sheet material subjected to surface treatment such as coated paper, a sheet material having a special shape such as an envelope or index paper, a plastic film, and cloth, can be used.

The image forming apparatus 1 includes a main body 1B including an image forming unit 1A serving as an image forming unit and a housing 1C that accommodates the image forming unit 1A. The image forming unit 1A includes a photosensitive drum 8, a charging roller 80, an exposure device 7, a developing unit 81, and a transfer roller 9. The main body 1B includes a cassette 2, a feed roller 3, a conveyance roller pair 4, a registration roller pair 5, a fixing device 10, a discharge roller pair 11 (discharge rollers), a body case (body frame or body casing) 18 including a discharge tray 12, and a front door 13.

In the following description and drawings, a vertical direction (direction of gravity) when the image forming apparatus 1 is installed on a horizontal plane is referred to as a Z-axis direction. A direction of a rotation axis of the photosensitive drum 8 included in the image forming apparatus 1 is referred to as an X-axis direction. A direction intersecting both the X-axis direction and the Z-axis direction is referred to as a Y-axis direction. The X-axis direction, the Y-axis direction, and the Z-axis direction may preferably be orthogonal to one another. In the present embodiment, the X-axis direction is the direction of the rotation axis of the discharge roller pair 11. The horizontal plane is a plane parallel to the X-axis direction and the Y-axis direction. The X-axis direction can also be referred to as a width direction of the sheet S. A direction of a rotation axis of a rotary member (for example, the feed roller 3, the conveyance roller pair 4, the registration roller pair 5, and the discharge roller pair 11 (discharge rollers)) that conveys the sheet S is parallel to the X-axis direction.

The body case 18 includes a cover member that forms an external appearance surface of the image forming apparatus 1 and a frame member such as a sheet metal that forms a frame of the image forming apparatus 1. The body case 18 and the front door 13 form the housing 1C of the image forming apparatus 1. The front door 13 is an opening/closing member movable between a closing position where an opening portion OP provided in the body case 18 is closed and an opening position where the opening portion OP is opened. By opening the front door 13, a user is allowed access to the inside of the housing 1C through the opening portion OP, and for example, a process cartridge 6 described below can be replaced. At least a part of the front door 13 forms the external appearance surface of the image forming apparatus 1 together with the cover member of the body case 18.

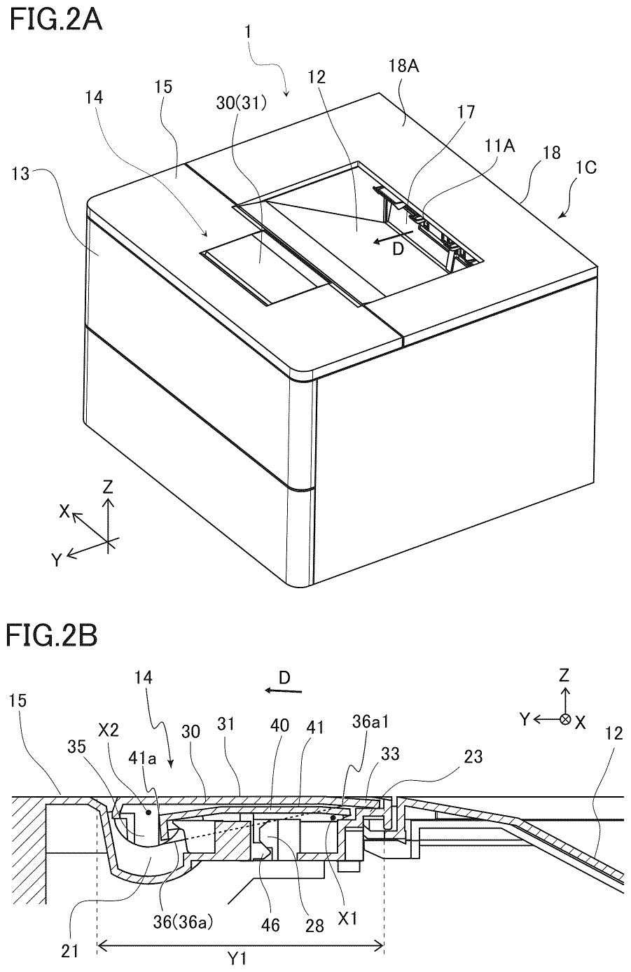

The body case 18 includes a discharge opening 11A, an upper surface portion including a top surface 18A and the discharge tray 12, and a wall surface 17 (support wall or alignment wall) (see also FIGS. 2A and 2B). The upper surface portion of the body case 18 forms an upper surface portion of the housing 1C together with a top surface 15 of the front door 13. That is, the upper surface portion of the housing 1C in the present embodiment includes the top surface 18A of the body case 18, the discharge tray 12, and the top surface 15 of the front door 13.

The top surface 18A of the body case 18 is a surface that extends in a direction intersecting the Z-axis direction and faces upward. The top surface 18A may have a planar shape orthogonal to the Z-axis direction. The discharge tray 12 is a surface extending downstream in a sheet discharge direction D from a position below the discharge opening 11A. The discharge tray 12 is an inclined surface (first surface) inclined upward while extending downstream in the sheet discharge direction D. In the present embodiment, a downstream end of the discharge tray 12 in the sheet discharge direction D is adjacent to the top surface 15 of the front door 13 and an extension tray portion 14 described below (FIG. 2A).

The top surface 15 of the front door 13 is a surface that extends in a direction intersecting the Z-axis direction and faces upward. The top surface 15 of the front door 13 is a second surface provided downstream of the discharge tray 12 (first surface) in the sheet discharge direction D, and is an example of the second surface of the housing 1C in which an angle between the second surface and the horizontal plane is smaller than an angle between the first surface and the horizontal plane. In other words, the angle defined by the top surface 15 of the front door 13 and a horizontal direction (an inclination angle of the top surface 15 with respect to the horizontal direction) is smaller than an angle between defined by the discharge tray 12 and the horizontal direction (an inclination angle of the discharge tray 12 with respect to the horizontal direction). The discharge tray 12 (first surface) and the top surface 15 (second surface) of the front door 13 are configured to receive the sheet S discharged by the discharge roller pair 11.

At least a part of the discharge tray 12 and at least a part of the discharge opening 11A are positioned at the same position in the X-axis direction. That is, the position of the discharge opening 11A and the position of the discharge tray 12 at least partially overlap each other in the X-axis direction. At least a part of the top surface 15 and at least a part of the discharge opening 11A are positioned at the same position in the X-axis direction. That is, the position of the discharge opening 11A and the position of the top surface 15 at least partially overlap each other in the X-axis direction.

The top surface 15 of the front door 13 may be a plane orthogonal to the Z-axis direction. Alternatively, a part of or the entire top surface 15 of the front door 13 may extend downstream in the sheet discharge direction D and be inclined upward or downward.

In the present embodiment, an example in which the discharge tray 12 serving as the first surface is provided in the body case 18, and the top surface 15 serving as the second surface is provided in the front door 13 (opening/closing member) will be described. In addition, in the present embodiment, an example in which the extension tray portion 14 and an extension tray housing portion 21 (recess) described below are provided in the front door 13 (opening/closing member) will be described. Alternatively, the second surface, the extension tray portion 14, and the extension tray housing portion 21 (recess) may be provided in the body case 18. The housing 1C does not have to include the front door 13 (opening/closing member). Further, the discharge tray 12 may be formed by the body case 18 and the front door 13. For example, the body case 18 and the front door 13 may be divided at an intermediate portion of the discharge tray 12. In addition, an inclined surface inclined with respect to the top surface 15 may be provided as a part of an upper surface of the front door 13, and both the inclined surface of the front door 13 and the discharge tray 12 of the body case 18 may be configured to receive the sheet S. In this case, the inclined surface of the front door 13 and the discharge tray 12 of the body case 18 may form a continuous inclined surface. The top surface 15 may be formed by the body case 18 and the front door 13.

The discharge opening 11A is an opening of the housing 1C through which the sheet S discharged in the sheet discharge direction D passes. The discharge roller pair 11 is configured to discharge the sheet S on which an image is formed by the image forming unit 1A through the discharge opening 11A.

The wall surface 17 is provided upstream of the discharge tray 12 (first surface) in the sheet discharge direction D and below the discharge opening 11A, and extends in a top-bottom direction. The discharge opening 11A is formed in the wall surface 17 or between an upper end of the wall surface 17 and the top surface 18A of the body case 18.

A part of or the entire image forming unit 1A may be a cartridge detachable from the main body 1B. In the present embodiment, the image forming apparatus 1 includes the process cartridge 6 detachable from the main body 1B. The process cartridge 6 includes the photosensitive drum 8, the charging roller 80, and the developing unit 81. The process cartridge 6 is detachable from the main body 1B through the opening portion OP by opening the front door 13 of the main body 1B.

The image forming apparatus 1 may include a drum cartridge and a developing cartridge, which are detachable from the main body 1B, instead of the process cartridge 6, and the drum cartridge and the developing cartridge may be detachable from each other. In this case, the drum cartridge may include the photosensitive drum 8 and the charging roller 80, and the developing cartridge may include the developing unit 81.

The photosensitive drum 8 functions as an image bearing member that bears a latent image and a developer image (toner image). The photosensitive drum 8 is a drum-type electrophotographic photosensitive member (hereinafter, referred to as the photosensitive drum 8). The photosensitive drum 8 is formed by forming a photosensitive layer on an outer peripheral portion of a cylindrical base made of aluminum, nickel, or the like using a photosensitive material such as organic photo-semiconductor (organic photoconductor (OPC)), amorphous selenium, or amorphous silicon. The photosensitive drum 8 is rotatably supported by the main body 1B, and is configured to be rotationally driven by a drive source disposed in the main body 1B. The charging roller 80 is an example of a charger that performs charging processing on a surface of the photosensitive drum 8. The developing unit 81 includes a toner storage (developing container) that stores toner serving as a developer, and a developing roller (developer bearer) that bears the toner and supplies the toner to the photosensitive drum 8.

The exposure device 7 includes a laser light source and an optical system that guides laser light emitted from the laser light source to the photosensitive drum 8. The exposure device 7 of the present embodiment is disposed above the process cartridge 6. The exposure device 7 may be a light emitting diode (LED) exposure device including a plurality of LED light sources arranged in a rotation axis direction (main scanning direction) of the photosensitive drum 8. The transfer roller 9 faces the photosensitive drum 8 and forms a transfer portion (transfer nip) between the transfer roller 9 and the photosensitive drum 8.

The cassette 2 is a housing portion in which the sheets S are supported and housed. The feed roller 3 is an example of a feeding unit that feeds the sheet S from the cassette 2. The fixing device 10 is a heat fixing type unit (image heating device), and includes, for example, a heating roller, a pressure roller that forms a fixing nip together with the heating roller, and a heat source such as a halogen lamp that heats the heating roller. The discharge roller pair 11 is an example of a discharge unit that discharges the sheet S from the inside to the outside of the housing 1C.

In the present embodiment, a movement direction of the sheet S at a contact portion with the discharge roller pair 11 is defined as the sheet discharge direction D. That is, the sheet discharge direction D of the present embodiment is perpendicular to a straight line connecting the center of one roller of the discharge roller pair 11 and the center of the other roller of the discharge roller pair 11 when viewed in the X-axis direction. In the present embodiment, the sheet discharge direction D is a direction along the Y-axis direction. The sheet discharge direction D may be parallel to the Y-axis direction or may be a direction intersecting the Y-axis direction. However, the sheet discharge direction D is a direction intersecting the Z-axis direction (vertical direction).

The discharge tray 12 is provided at the upper surface portion of the housing 1C. The discharge tray 12 supports a lower surface of the sheet S discharged by the discharge roller pair 11. At least a part of the discharge tray 12 is inclined upward in the vertical direction while extending downstream in the sheet discharge direction D.

### Image Forming Operation

An operation of the image forming apparatus 1 will be described. For example, in a case where an image forming operation execution instruction (print instruction) including the image information is received from the external equipment, the image forming apparatus 1 performs an image forming operation which is a series of operations of forming an image on the sheet S while conveying the sheets S one by one.

In the image forming operation, the toner image is created in the image forming unit 1A. Specifically, the photosensitive drum 8 is rotationally driven by a driving force of the drive source. The surface of the photosensitive drum 8 is uniformly charged to a predetermined polarity and potential by the charging roller 80. The exposure device 7 irradiates the photosensitive drum 8 with light based on the image information to perform exposure, and writes an electrostatic latent image on the surface of the photosensitive drum 8. The developing unit 81 supplies the charged toner to the photosensitive drum 8, and develops the electrostatic latent image into the toner image. The toner image is conveyed to the transfer portion by the rotation of the photosensitive drum 8.

On the other hand, the sheet S is conveyed from the cassette 2 toward the transfer portion in parallel with the operation of the image forming unit 1A. Specifically, the feed roller 3 feeds the uppermost sheet S of a sheet bundle housed in the cassette 2. The fed sheet S is conveyed to the registration roller pair 5 via the conveyance roller pair 4. The registration roller pair 5 conveys the sheet S to the transfer portion at a timing when the toner image on the photosensitive drum 8 reaches the transfer portion. Then, by applying a transfer voltage to the transfer roller 9, the toner image is transferred from the photosensitive drum 8 to the sheet S at the transfer portion.

The sheet S to which the toner image has been transferred at the transfer portion is conveyed to the fixing device 10. The fixing device 10 performs fixing processing of heating and pressurizing the toner image on the sheet S while nipping and conveying the sheet S at the fixing nip. The image fixed to the sheet S is obtained by the fixing processing. The sheet S having passed through the fixing device 10 is discharged to the outside of the housing 1C by the discharge roller pair 11, and is supported on the discharge tray 12.

The sheet S discharged onto the discharge tray 12 slides down upstream in the sheet discharge direction D along the inclination of the discharge tray 12. Then, the sheet S stops by abutting against the wall surface 17 (support wall or alignment wall) of the housing 1C provided at an upstream end of the discharge tray 12 in the sheet discharge direction D, or receiving a frictional force from the discharge tray 12 or another sheet S already supported.

### Extension Tray Portion

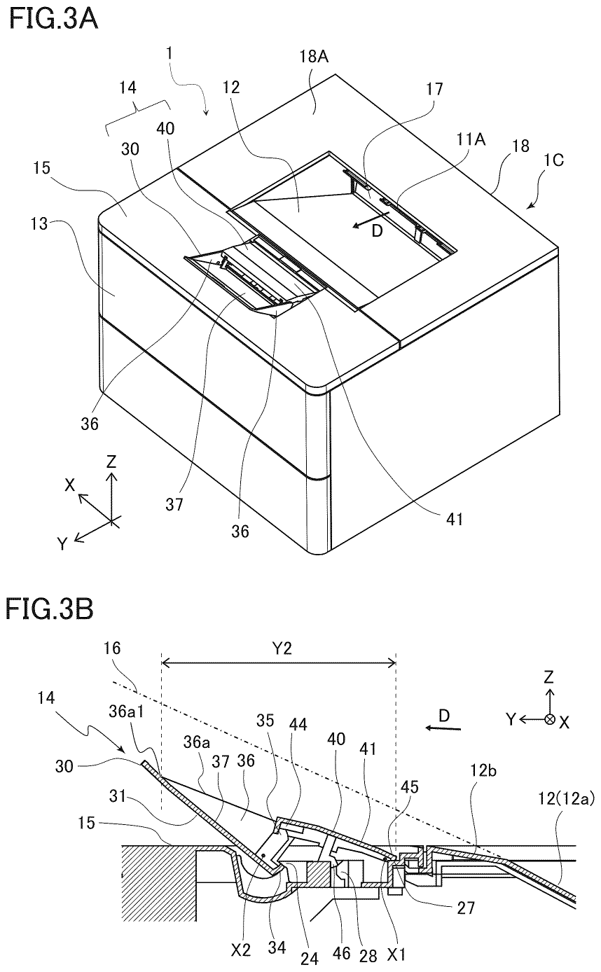

The extension tray portion 14 provided in the image forming apparatus 1 will be described with reference to FIGS. 1 to 5B. FIG. 2A is a perspective view illustrating the image forming apparatus 1 when the extension tray portion 14 is in a housed state. FIG. 2B is a cross-sectional view of the extension tray portion 14 illustrated in FIG. 2A taken along an imaginary plane perpendicular to the X-axis direction. FIG. 3A is a perspective view illustrating the image forming apparatus 1 when the extension tray portion 14 is in an extended state. FIG. 3B is a cross-sectional view of the extension tray portion 14 illustrated in FIG. 3A taken along the imaginary plane perpendicular to the X-axis direction.

As illustrated in FIGS. 1 and 3A, the extension tray portion 14 includes a first extension tray 40 and a second extension tray 30. At least a part of the extension tray portion 14 and at least a part of the discharge opening 11A are positioned at the same position in the X-axis direction. That is, the position of the discharge opening 11A and the position of the extension tray portion 14 (positions of the first extension tray 40 and the second extension tray 30) at least partially overlap each other in the X-axis direction.

The first extension tray 40 and the second extension tray 30 are disposed at the upper surface portion of the housing 1C (the upper surface portion of the front door 13 in the present embodiment). The first extension tray 40 is movable (pivotable) between a first retracted position (first housed position or first closing position) illustrated in FIGS. 2A and 2B and a first use position (first extended position or first opening position) illustrated in FIGS. 3A and 3B. The second extension tray 30 is pivotable between a second retracted position (second housing position or second closing position) illustrated in FIGS. 2A and 2B and a second use position (second extended position or second opening position) illustrated in FIGS. 3A and 3B. The first extension tray 40 is pivotable around a pivot axis (rotation axis) X1. The second extension tray 30 is pivotable around a pivot axis (rotation axis) X2.

A state in which the first extension tray 40 is at the first retracted position and the second extension tray 30 is at the second retracted position is referred to as the housed state (first state) of the extension tray portion 14. A state in which the first extension tray 40 is at the first use position and the second extension tray 30 is at the second use position is referred to as the extended state (second state) of the extension tray portion 14.

In the case of changing the extension tray portion 14 from the housed state to the extended state, the user pivots the second extension tray 30 in a counterclockwise direction in FIG. 2B. Further, in the case of changing the extension tray portion 14 from the extended state to the housed state, the user pivots the second extension tray 30 in a clockwise direction in FIG. 3B.

In the extended state of the extension tray portion 14, the first extension tray 40 and the second extension tray 30 can support the sheet S discharged by the discharge roller pair 11 together with the discharge tray 12. On the other hand, in the housed state of the extension tray portion 14, the first extension tray 40 and the second extension tray 30 are retracted downward as compared with the extended state. When the user does not use the extension tray portion 14 or when the image forming apparatus 1 is transported, it may be preferable to bring the extension tray portion 14 into the housed state.

The first extension tray 40 has an upper surface 41 serving as a third surface. The upper surface 41 faces upward in each of a state in which the second extension tray 30 is at the second retracted position (FIGS. 2A and 2B) and a state in which the second extension tray 30 is at the second use position (FIGS. 3A and 3B).

The second extension tray 30 has a first face 31 (fifth surface), a second face 37 on a back side of the first face 31, and ribs 36. The second face 37 faces upward in the Z-axis direction in a state in which the second extension tray 30 is at the second use position (FIGS. 3A and 3B). The first face 31 faces upward in the Z-axis direction in a state in which the second extension tray 30 is at the second retracted position (FIGS. 2A and 2B).

The rib 36 is formed so as to protrude from the second face 37 in a state in which the second extension tray 30 is at the second use position (FIGS. 3A and 3B). The ribs 36 are provided at both ends of the second face 37 in the X-axis direction, and each extend in a direction intersecting the X-axis direction. A top surface 36a of the rib 36 functions as a fourth surface capable of receiving the sheet S together with the upper surface 41 (third surface) of the first extension tray 40 in a state in which the second extension tray 30 is at the second use position (FIGS. 3A and 3B).

The second face 37 of the second extension tray 30 extends downstream of the rib 36 in the sheet discharge direction D in a state in which the second extension tray 30 is at the second use position (FIGS. 3A and 3B). Therefore, the second face 37 can receive the sheet S at a position downstream of a downstream end (36a1) of the rib 36 in the sheet discharge direction D.

The first extension tray 40 and the second extension tray 30 of the present embodiment are supported by the front door 13. The extension tray housing portion 21, which is a recess recessed downward from the top surface 15 (second surface) of the front door 13, is formed at the upper surface portion of the front door 13 (the upper surface portion of the housing 1C). The extension tray housing portion 21 forms a space for accommodating the first extension tray 40 at the first retracted position and the second extension tray 30 at the second retracted position.

In the housed state of the extension tray portion 14 in the present embodiment, the second extension tray 30 and the first extension tray 40 are housed in the extension tray housing portion 21 in a state in which the second extension tray 30 overlaps the first extension tray 40 (FIGS. 2A and 2B). In the housed state of the extension tray portion 14, the entire first extension tray 40 is covered by the second extension tray 30. In other words, the first extension tray 40 is not exposed when viewed from above in the vertical direction (FIG. 2A).

The first face 31, which is the upper surface of the second extension tray 30 in the housed state of the extension tray portion 14, forms substantially the same surface as the top surface 15 of the front door 13. That is, at least a part of the first face 31 overlaps the top surface 15 of the front door 13 when viewed in a direction (X-axis direction) orthogonal to both the sheet discharge direction D and the vertical direction (Z-axis direction). In the housed state of the extension tray portion 14, the first face 31 of the second extension tray 30 may slightly protrude from the top surface 15 of the front door 13 or may be slightly recessed from the top surface 15. In the housed state of the extension tray portion 14, the first face 31 of the second extension tray 30 may be parallel to the top surface 15 of the front door 13.

In the housed state of the extension tray portion 14, the first face 31 of the second extension tray 30 can receive the lower surface of the sheet S together with the top surface 15 of the front door 13. That is, the first face 31 of the second extension tray 30 is a fifth surface described below, which faces a side opposite to a side that the top surface 36a (fourth surface) of the rib 36 faces, and functions as the fifth surface that receives the sheet discharged by the discharge roller pair 11 in a state in which the second extension tray 30 is at the second retracted position. In the housed state of the extension tray portion 14, the top surface 36a (fourth surface) of the rib 36 faces downward.

In the housed state of the extension tray portion 14, the first face 31 of the second extension tray 30 forms an upper surface of the image forming apparatus 1 together with the top surface 15 of the front door 13. In this state, the first face 31 and the upper surface 41 of the first extension tray 40 at least partially overlap each other when viewed in the direction of gravity. On the other hand, in the present embodiment, in the housed state of the extension tray portion 14, the entire first extension tray 40 is covered by the second extension tray 30 when viewed in the direction of gravity, and the upper surface 41 of the first extension tray 40 does not come into contact with the sheet S.

A width Y1 (FIG. 2B) of the extension tray housing portion 21 (recess) in the sheet discharge direction D is smaller than a length Y2 (FIG. 3B) when the extension tray portion 14 is extended. The length Y2 is a length from an upstream end of the upper surface 41 (third surface) of the first extension tray 40 to a downstream end of the top surface 36a (fifth surface) of the rib 36 in the sheet discharge direction D when the first extension tray 40 is at the first use position and the second extension tray 30 is at the second use position. As described above, since the first extension tray 40 and the second extension tray 30 can be accommodated in the extension tray housing portion 21 (recess) having a small width Y1, the configuration of the present embodiment is advantageous for miniaturization of the image forming apparatus 1.

In the housed state of the extension tray portion 14, the entire first face 31 does not necessarily have to form the same surface as the top surface 15 of the front door 13. For example, the vicinity of an upstream end of the first face 31 in the sheet discharge direction D may be slightly inclined downward, and the upstream end of the first face 31 may be positioned lower than the top surface 15 of the front door 13. With such a configuration, it is possible to prevent a leading edge of the sheet S from being caught by the upstream end of the first face 31.

In the extended state of the extension tray portion 14 illustrated in FIGS. 3A and 3B, at least a part of the upper surface 41 (third surface) of the first extension tray 40 is positioned downstream of the discharge tray 12 (first surface) in the sheet discharge direction D and protrudes upward from the top surface 15 (second surface) of the front door 13. In the extended state of the extension tray portion 14, at least a part of the upper surface 41 (third surface) of the first extension tray 40 is inclined upward as it extends downstream in the sheet discharge direction D.

In the extended state of the extension tray portion 14, at least a part of the top surface 36a (fourth surface) of the rib 36 of the second extension tray 30 protrudes upward from the discharge tray 12 (first surface) and the upper surface 41 (third surface) of the first extension tray 40. In the extended state of the extension tray portion 14, at least a part of the top surface 36a (fourth surface) of the rib 36 of the second extension tray 30 is positioned downstream of the upper surface 41 (third surface) of the first extension tray 40 in the sheet discharge direction D. In the extended state of the extension tray portion 14, at least a part of the top surface 36a (fourth surface) of the rib 36 of the second extension tray 30 is inclined upward as it extends downstream in the sheet discharge direction D.

When the second extension tray 30 is pivoted from the second retracted position to the second use position, the first extension tray 40 is moved from the first retracted position to the first use position by a pressing rib 35 (interlocking portion) described below. When the first extension tray 40 moves from the first retracted position to the first use position, at least a part of the upper surface (third surface) of the first extension tray 40 moves upward. In particular, a downstream end of the upper surface (third surface) of the first extension tray 40 in the sheet discharge direction D moves upward.

In this manner, in the extended state of the extension tray portion 14, each of the upper surface 41 (third surface) of the first extension tray 40 and the top surface 36a (fourth surface) of the rib 36 of the second extension tray 30 forms an inclined surface capable of receiving the lower surface of the sheet S together with the discharge tray 12 (first surface). In the extended state of the extension tray portion 14, the discharge roller pair 11 can convey the sheet S to a position where the sheet S comes into contact with the upper surface 41 (third surface) of the first extension tray 40 and the top surface 36a (fourth surface) of the rib 36 of the second extension tray 30.

A position of at least a part of the upper surface 41 (third surface) in the direction of gravity when the first extension tray 40 is at the first use position (FIG. 3B) may preferably be higher than a position of the first face 31 (fifth surface) when the second extension tray 30 is at the second retracted position (FIG. 2B). That is, when the extension tray portion 14 in the housed state is extended, the upper surface 41 of the first extension tray 40 may preferably protrude to a position higher than the position of the first face 31 of the second extension tray 30, which is the upper surface of the extension tray portion 14 in the housed state.

In the second extension tray 30, the top surface 36a includes both end portions, and one of the both end portions is an end portion (tip end portion) 36a1 that is farther from the pivot axis X2 than the other of the both end portions is from the pivot axis X2. It may be preferable that the end portion 36a1 of the top surface 36a of the rib 36 on a side farther from a pivot axis X2 of the second extension tray 30 is pivoted so as to cross the pivot axis X2. That is, it may be preferable that, when the second extension tray 30 is at the second retracted position (FIG. 2B), the end portion 36a1 of the top surface 36a (fourth surface) of the rib 36 on the side farther from the pivot axis X2 is positioned upstream of the pivot axis X2 in the sheet discharge direction D. Further, it may be preferable that, when the second extension tray 30 is at the second use position (FIG. 3B), the end portion 36a1 of the top surface 36a (fourth surface) of the rib 36 is positioned downstream of the pivot axis X2 in the sheet discharge direction D.

It may be preferable that, when the second extension tray 30 is at the second retracted position, the end portion 36a1 of the top surface 36a (fourth surface) of the rib 36 is positioned upstream of a downstream end 41a of the upper surface 41 (third surface) of the first extension tray 40 in the sheet discharge direction D (FIG. 2B).

As illustrated in FIG. 3B, an imaginary straight line drawn along the discharge tray 12 when viewed in the X-axis direction is defined as an extension line 16 of the discharge tray 12. In a case where the inclination angle of the discharge tray 12 with respect to the horizontal plane (the inclination angle with respect to the horizontal direction) is not uniform, the extension line 16 indicates an imaginary straight line drawn along a region where the inclination angle of the discharge tray 12 is the largest. For example, the discharge tray 12 may include a first inclined portion 12a inclined at a first inclination angle with respect to the horizontal plane and a second inclined portion 12b positioned downstream of the first inclined portion 12a in the sheet discharge direction D and inclined at a second inclination angle smaller than the first inclination angle with respect to the horizontal plane. In this case, the extension line 16 is an imaginary straight line drawn along the first inclined portion 12a.

It may be preferable that an inclination angle of the top surface 36a (fourth surface) of the rib 36 of the second extension tray 30 with respect to the horizontal plane and an inclination angle of the upper surface 41 (third surface) of the first extension tray 40 with respect to the horizontal plane in the extended state of the extension tray portion 14 are close to an inclination angle of the extension line 16 of the discharge tray 12. As a result, in the extended state of the extension tray portion 14, the sheet S can more smoothly slide on the top surface 36a (fourth surface) of the rib 36 of the second extension tray 30 and the upper surface 41 (third surface) of the first extension tray 40.

### Details of Each Extension Tray

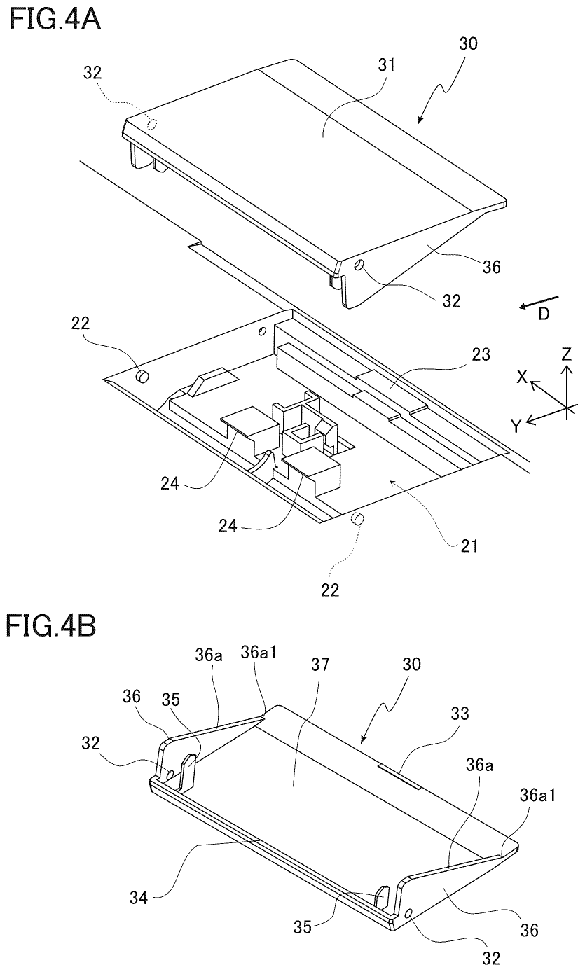

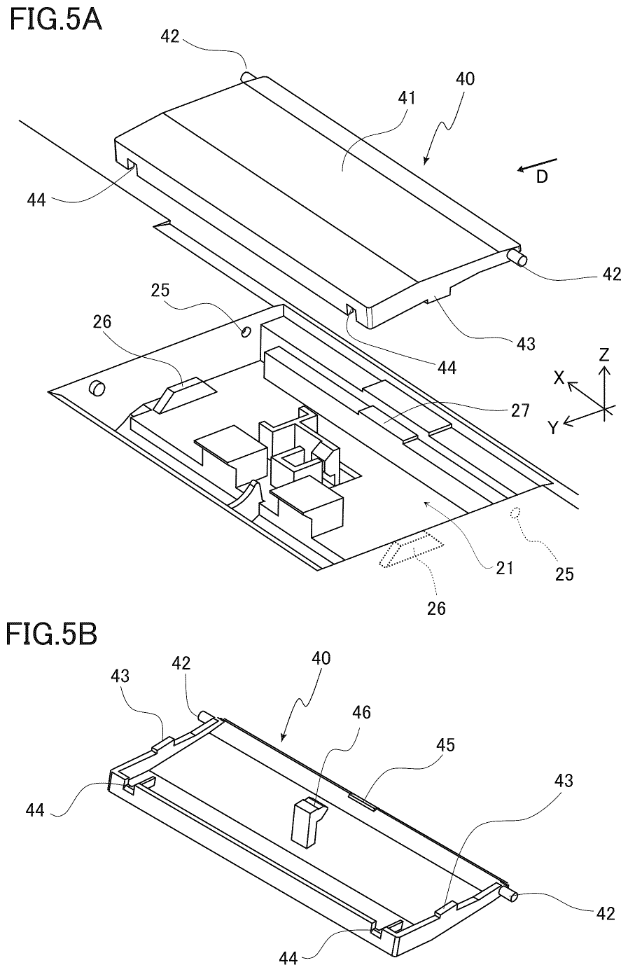

Details of the first extension tray 40 and the second extension tray 30 will be further described with reference to FIGS. 4A to 5B. FIG. 4A is an exploded perspective view illustrating the second extension tray 30 and the extension tray housing portion 21. FIG. 4B is a perspective view of the second extension tray 30 when viewed from a side of the second face 37. FIG. 5A is an exploded perspective view illustrating the first extension tray 40 and the extension tray housing portion 21. FIG. 5B is a perspective view of the first extension tray 40 when viewed from a back side of the upper surface 41.

### (1) Second Extension Tray

As illustrated in FIGS. 4A and 4B, the second extension tray 30 includes the first face 31, the second face 37, the rib 36, a pivot hole 32, a first contact portion 33, a second contact portion 34, and the pressing rib 35.

The second extension tray 30 of the present embodiment has a plate portion (tray body) including the first face 31 and the second face 37 on a back side of the first face 31. The second extension tray 30 of the present embodiment includes the first rib 36 provided at one end of the plate portion in a direction of the pivot axis X2 (pivot axis direction) of the second extension tray 30 and the second rib 36 provided at the other end of the plate portion. Each rib 36 extends in a direction intersecting the pivot axis direction of the second extension tray 30. The number of ribs 36 may be one or two or more.

The pivot holes 32 are formed on both side portions of the second extension tray 30 in the X-axis direction. The pivot hole 32 of the present embodiment is formed in each of the two ribs 36 forming the end surfaces of the second extension tray 30 in the X-axis direction.

Each of the two pivot holes 32 is engaged with a pivot shaft 22 provided in the extension tray housing portion 21. The second extension tray 30 is pivotable around the pivot axis X2 (second pivot axis) passing through the center of the pivot shaft 22. The pivot axis X2 of the second extension tray 30 is positioned downstream of the pivot axis X1 (first pivot axis) of the first extension tray 40. It may be preferable that the pivot axis X1 extends along the pivot axis X2, and it may be more preferable that the pivot axis X1 and the pivot axis X2 are parallel to each other. The pivot axis direction of the first extension tray 40 and the pivot axis direction of the second extension tray 30 may be directions orthogonal to both the sheet discharge direction D and the direction of gravity. A shaft portion may be disposed in the second extension tray 30, and a pivot hole engaged with the shaft portion may be disposed in the extension tray housing portion 21.

Each of the first contact portion 33 and the second contact portion 34 is formed at a position away from the pivot axis X2 of the second extension tray 30. In the present embodiment, the first contact portion 33 is formed at one end portion of the second face 37 in a direction intersecting the pivot axis X2, and the second contact portion 34 is formed at the other end portion of the second face 37 in the direction intersecting the pivot axis X2. The first contact portion 33 can come into contact with a first contacted portion 23 provided in the extension tray housing portion 21. The second contact portion 34 can come into contact with a second contacted portion 24 provided in the extension tray housing portion 21.

In the housed state of the extension tray portion 14 (FIG. 2B), the second extension tray 30 is positioned by contact between the first contact portion 33 and the first contacted portion 23. Specifically, the center of gravity of the second extension tray 30 at the second retracted position illustrated in FIG. 2B is positioned upstream of the pivot axis X2 in the sheet discharge direction D. Therefore, a moment in the clockwise direction in FIG. 2B acts on the second extension tray 30 around the pivot axis X2 by a weight of the second extension tray 30. The first contacted portion 23 of the extension tray housing portion 21 supports the first contact portion 33 of the second extension tray 30 against the moment, whereby the second extension tray 30 is held at the second retracted position.

In the extended state of the extension tray portion 14 (FIG. 3B), the second extension tray 30 is positioned by contact between the second contact portion 34 and the second contacted portion 24. Specifically, the center of gravity of the second extension tray 30 at the second use position illustrated in FIG. 3B is positioned downstream of the pivot axis X2 in the sheet discharge direction D. Therefore, a moment in the counterclockwise direction in FIG. 3B acts on the second extension tray 30 around the pivot axis X2 by a weight of the second extension tray 30. The second contacted portion 24 of the extension tray housing portion 21 supports the second contact portion 34 of the second extension tray 30 against the moment, whereby the second extension tray 30 is held at the second use position.

The pressing rib 35 protrudes from the plate portion of the second extension tray 30 in a direction intersecting the pivot axis X2 of the second extension tray 30 (upward in FIGS. 4A and 4B). The pressing rib 35 moves by rotating around the pivot axis X2 of the second extension tray 30 along with the pivoting of the second extension tray 30. The pressing rib 35 functions as the interlocking portion that moves the first extension tray 40 in conjunction with the pivoting of the second extension tray 30.

In the present embodiment, one pressing rib 35 is disposed on each side of the center of the second face 37 in the direction of the pivot axis X2 of the second extension tray 30. In the present embodiment, the two pressing ribs 35 are disposed between the two ribs 36 (first and second ribs) in the direction of the pivot axis X2 of the second extension tray 30.

### (2) First Extension Tray

As illustrated in FIGS. 5A and 5B, the first extension tray 40 includes the upper surface 41, pivot shafts 42, a first contact portion 43, a pressed portion 44, a second contact portion 45, and a hook portion 46.

The pivot shafts 42 are formed on both side portions of the first extension tray 40 in the X-axis direction. The two pivot shafts 42 are respectively engaged with pivot holes 25 provided in the extension tray housing portion 21. The first extension tray 40 is pivotable around the pivot axis X1 (first pivot axis) passing through the center of the pivot shaft 42. A pivot hole may be disposed in the first extension tray 40, and a pivot shaft engaged with the pivot hole may be disposed in the extension tray housing portion 21.

The pressed portion 44 is a force receiving portion that receives a force from the pressing rib 35 (interlocking portion) of the second extension tray 30. The pressed portion 44 is disposed downstream of the pivot axis X1 of the first extension tray 40 in the sheet discharge direction D. The first extension tray 40 is configured to move from the first retracted position to the first use position when the pressed portion 44 is pressed upward by the pressing rib 35 of the second extension tray 30 (FIG. 3B). That is, the first extension tray 40 includes the force receiving portion (pressed portion 44) disposed downstream of the pivot axis X1 (first pivot axis) in the sheet discharge direction D. The first extension tray 40 is configured to move from the first retracted position to the first use position when the force receiving portion (pressed portion 44) receives an upward force from the interlocking portion (pressing rib 35).

When the second extension tray 30 is pivoted from the second use position toward the second retracted position, the pressing rib 35 moves downward to release the pressing of the pressed portion 44, so that the first extension tray 40 moves from the first use position to the first retracted position by a weight of the first extension tray 40.

Each of the first contact portion 43 and the second contact portion 45 is formed at a position away from the pivot axis X1 of the first extension tray 40. In the present embodiment, the first contact portion 43 is formed at one end portion of the upper surface 41 in a direction intersecting the pivot axis X1, and the second contact portion 45 is formed at the other end portion of the upper surface 41 in the direction intersecting the pivot axis X1. The first contact portion 43 can come into contact with a third contacted portion 26 provided in the extension tray housing portion 21. The second contact portion 45 can come into contact with a fourth contacted portion 27 provided in the extension tray housing portion 21.

In the housed state of the extension tray portion 14 (FIG. 2B), the first extension tray 40 is positioned by contact between the first contact portion 43 and the third contacted portion 26. Specifically, the center of gravity of the first extension tray 40 at the first retracted position illustrated in FIG. 2B is positioned downstream of the pivot axis X1 in the sheet discharge direction D. Therefore, a moment in the counterclockwise direction in FIG. 2B acts on the first extension tray 40 around the pivot axis X1 by the weight of the first extension tray 40. The third contacted portion 26 of the extension tray housing portion 21 supports the first contact portion 43 of the first extension tray 40 against the moment, whereby the first extension tray 40 is held at the first retracted position.

In the extended state of the extension tray portion 14 (FIG. 3B), the first extension tray 40 is positioned by contact between the pressing rib 35 and the pressed portion 44. Specifically, the center of gravity of the first extension tray 40 at the first use position illustrated in FIG. 3B is positioned downstream of the pivot axis X1 in the sheet discharge direction D. Therefore, a moment in the counterclockwise direction in FIG. 3B acts on the first extension tray 40 around the pivot axis X1 by the weight of the first extension tray 40. The pressing rib 35 of the second extension tray 30 supports the pressed portion 44 of the first extension tray 40 against the moment, whereby the first extension tray 40 is held at the first use position.

In the extended state of the extension tray portion 14 (FIG. 3B), the second contact portion 45 of the first extension tray 40 faces the fourth contacted portion 27 of the extension tray housing portion 21. Assume that an external force in the clockwise direction acts on the first extension tray 40 around the pivot axis X1 in FIG. 3B in the extended state of the extension tray portion 14. Even in this case, the second contact portion 45 of the first extension tray 40 comes into contact with the fourth contacted portion 27 of the extension tray housing portion 21, whereby the pivoting of the first extension tray 40 is prevented. That is, the second contact portion 45 of the first extension tray 40 and the fourth contacted portion 27 of the extension tray housing portion 21 can prevent the first extension tray 40 from unintentionally moving (a posture of the first extension tray 40 is disturbed) in the extended state of the extension tray portion 14.

The hook portion 46 protrudes from a surface of the first extension tray 40, which is opposite to the upper surface 41 (FIG. 5B). A tip of the hook portion 46 is bent in a key shape. The hook portion 46 can be engaged with a hook receiving protrusion 28 provided in the extension tray housing portion 21 (FIG. 2B). A bending direction of the tip of the hook portion 46 and a protruding direction of the hook receiving protrusion 28 are directions intersecting an arc centered on the pivot axis X1.

When the first extension tray 40 moves between the first retracted position (FIG. 2B) and the first use position (FIG. 3B), the tip of the hook portion 46 moves so as to climb over the hook receiving protrusion 28 while the hook portion 46 is elastically deformed. At this time, a click feeling can be imparted to an operation of the extension tray portion 14 by a resistance force received by the hook portion 46 from the hook receiving protrusion 28, so that operability of the extension tray portion 14 can be improved. Here, the click feeling means that, for example, when the user grips the second extension tray 30 and pivots the second extension tray 30 from the second retracted position to the second use position, an operation load felt by the user temporarily increases, and the operation load decreases until the second extension tray 30 reaches the second use position.

### Summary of Present Embodiment

In the extended state of the extension tray portion 14, each of the upper surface 41 (third surface) of the first extension tray 40 and the top surface 36a (fourth surface) of the rib 36 of the second extension tray 30 forms the inclined surface. The sheet S conveyed toward the discharge tray 12 and the extension tray portion 14 by the discharge roller pair 11 comes into contact with the discharge tray 12 (first surface), the upper surface 41 (third surface) of the first extension tray 40, and the top surface 36a (fourth surface) of the rib 36 of the second extension tray 30. Then, the sheet S slides down upstream in the sheet discharge direction D according to the inclinations of the discharge tray 12 (first surface), the upper surface 41 (third surface) of the first extension tray 40, and the top surface 36a (fourth surface) of the rib 36 of the second extension tray 30.

Therefore, according to the present embodiment, it is possible to provide a sheet discharge apparatus and an image forming apparatus capable of improving alignment of discharged sheets.

In a case where the first extension tray 40 is not provided, the top surface of the housing 1C (the top surface 15 of the front door 13) and the sheet S come into contact with each other between the discharge tray 12 and the second extension tray 30. In this case, the sheet S is less likely to slide down upstream in the sheet discharge direction D, and alignment of the sheets S in the discharge tray 12 may be deteriorated. The hindrance of the movement of the sheet S along the inclination of the discharge tray 12 in this manner is referred to as leaning of the sheet S.

According to the present embodiment, in the extended state of the extension tray portion 14, the upper surface 41 of the first extension tray 40 forms the inclined surface at a position downstream of the discharge tray 12 and upstream of the top surface 36a of the rib 36 of the second extension tray 30. Therefore, it is possible to make it difficult for the sheet S to lean, and it is possible to improve the alignment of the sheets S.

According to the present embodiment, the pressing rib 35 (interlocking portion) moves the first extension tray 40 from the first retracted position to the first use position in conjunction with an operation of pivoting the second extension tray 30 from the second retracted position to the second use position. Therefore, both the first extension tray 40 and the second extension tray 30 can be moved from the retracted positions to the use positions by a simple operation of pivoting the second extension tray 30, so that usability can be improved.

### Second Embodiment

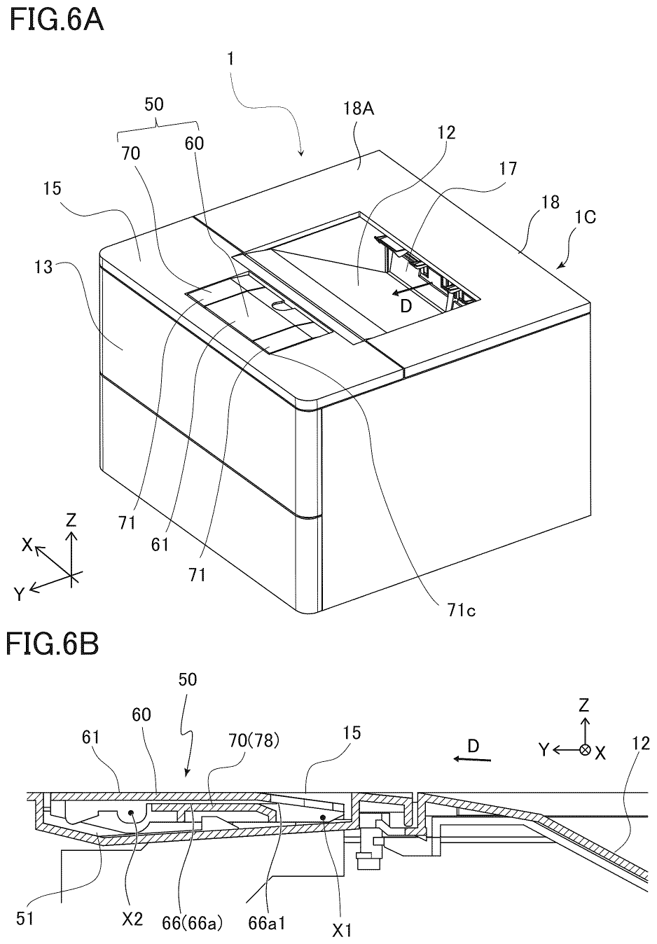

Another embodiment (second embodiment) of the present disclosure will be described with reference to FIGS. 6A to 8C. The present embodiment is different from the extension tray portion 14 of the first embodiment in a configuration of an extension tray portion 50. Hereinafter, elements denoted by reference numerals common to the first embodiment will have basically the same configurations and actions as those described in the first embodiment unless otherwise specified, and portions different from those of the first embodiment will be mainly described.

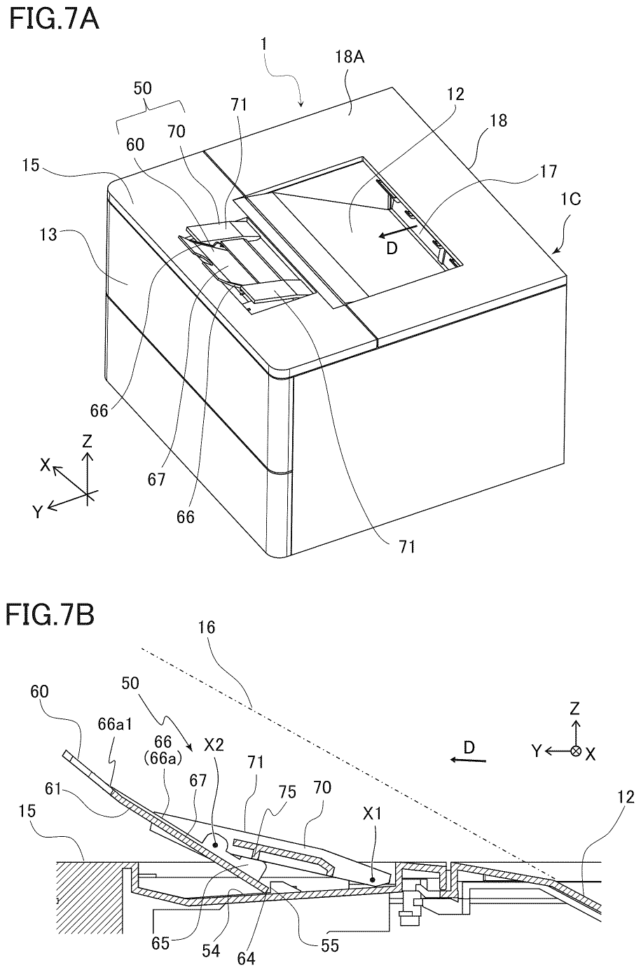

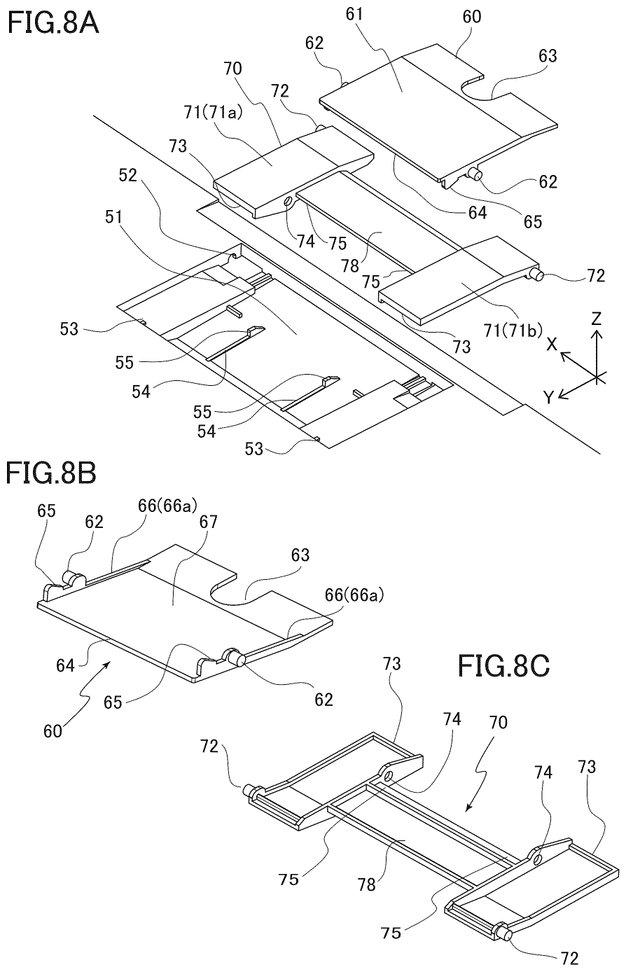

FIG. 6A is a perspective view illustrating an image forming apparatus 1 when the extension tray portion 50 is in a housed state. FIG. 6B is a cross-sectional view of the extension tray portion 50 illustrated in FIG. 6A taken along an imaginary plane perpendicular to an X-axis direction. FIG. 7A is a perspective view illustrating the image forming apparatus 1 when the extension tray portion 50 is in an extended state. FIG. 7B is a cross-sectional view of the extension tray portion 50 illustrated in FIG. 7A taken along an imaginary plane perpendicular to the X-axis direction. FIG. 8A is an exploded perspective view illustrating a first extension tray 70, a second extension tray 60, and an extension tray housing portion 51. FIG. 8B is a perspective view of the second extension tray 60 when viewed from a side of a second face 67. FIG. 8C is a perspective view of the first extension tray 70 when viewed from a back side of an upper surface 71.

As illustrated in FIGS. 6A to 7B, the extension tray portion 50 includes the first extension tray 70 and the second extension tray 60. The first extension tray 70 and the second extension tray 60 are disposed at an upper surface portion of a housing 1C (an upper surface portion of a front door 13 in the present embodiment). The first extension tray 70 is movable (pivotable) between a first retracted position (first housed position or first closing position) illustrated in FIGS. 6A and 6B and a first use position (first extended position or first opening position) illustrated in FIGS. 7A and 7B. The second extension tray 60 is pivotable between a second retracted position (second housing position or second closing position) illustrated in FIGS. 6A and 6B and a second use position (second extended position or second opening position) illustrated in FIGS. 7A and 7B.

A state in which the first extension tray 70 is at the first retracted position and the second extension tray 60 is at the second retracted position is referred to as the housed state (first state) of the extension tray portion 50. A state in which the first extension tray 70 is at the first use position and the second extension tray 60 is at the second use position is referred to as the extended state (second state) of the extension tray portion 50.

As illustrated in FIGS. 8A and 8C, the first extension tray 70 includes the upper surface 71 serving as a third surface, a pivot shaft 72, a first contact portion 73, a pivot hole 74, a pressed portion 75 (force receiving portion), and a coupling portion 78.

As illustrated in FIGS. 8A and 8B, the second extension tray 60 includes a first face 61 (fifth surface), a second face 67 on a back side of the first face 61, a pivot shaft 62, a groove portion 63, a second contact portion 64, a pressing rib 65 (interlocking portion), and a rib 66.

The pivot shaft 72 of the first extension tray 70 is engaged with a pivot hole 52 of the extension tray housing portion 51. The first extension tray 70 is pivoted around a pivot axis X1 (first pivot axis) passing through the center of the pivot shaft 72. That is, the first extension tray 70 is pivotably supported by the housing 1C. A pivot hole may be disposed in the first extension tray 70, and a pivot shaft engaged with the pivot hole may be disposed in the extension tray housing portion 51.

The pivot shaft 62 of the second extension tray 60 is engaged with the pivot hole 74 of the first extension tray 70. The second extension tray 60 is pivoted around a pivot axis X2 (second pivot axis) passing through the center of the pivot shaft 62. That is, the second extension tray 60 is pivotably supported by the first extension tray 70. The pivot axis X2 of the second extension tray 60 is movable (revolvable) around the pivot axis X1 of the first extension tray 70. A pivot hole may be disposed in the second extension tray 60, and a pivot shaft engaged with the pivot hole may be disposed in the first extension tray 70.

The first extension tray 70 and the second extension tray 60 of the present embodiment are supported by the front door 13. The extension tray housing portion 51, which is a recess recessed downward from a top surface 15 (second surface) of the front door 13, is formed at the upper surface portion of the front door 13 (the upper surface portion of the housing 1C). The extension tray housing portion 51 forms a space for accommodating the first extension tray 70 at the first retracted position and the second extension tray 60 at the second retracted position.

In the housed state of the extension tray portion 50 in the present embodiment, the second extension tray 60 and the first extension tray 70 are housed in the extension tray housing portion 51 in a state in which the upper surface 71 of the first extension tray 70 is aligned side by side with the first face 61 of the second extension tray 60 (FIGS. 6A and 6B). That is, in a state in which the first extension tray 70 is at the first retracted position and the second extension tray 60 is at the second retracted position, at least a part of the upper surface 71 (third surface) of the first extension tray 70 is exposed to the outside of the second extension tray 60. In this state, the upper surface 71 (third surface) of the first extension tray 70 can receive a sheet S together with the first face 61 (fifth surface) of the second extension tray 60. In the housed state of the extension tray portion 50, a top surface 66a (fourth surface) of the rib 66 faces downward.

The upper surface 71 of the first extension tray 70 and the upper surface (first face 61) of the second extension tray 60 in the housed state form substantially the same surface as the top surface 15 of the front door 13. That is, at least a part of the upper surface 71 and at least a part of the first face 61 overlap the top surface 15 of the front door 13 when viewed in a direction (X-axis direction) orthogonal to both a sheet discharge direction D and a vertical direction (Z-axis direction). In the housed state of the extension tray portion 50, the upper surface 71 of the first extension tray 70 and the upper surface (first face 61) of the second extension tray 60 may slightly protrude from the top surface 15 of the front door 13 or may be slightly recessed from the top surface 15.

In the present embodiment, the upper surface 71 of the first extension tray 70 is divided into two regions 71a and 71b separated in the X-axis direction (FIG. 8A). The two regions 71a and 71b are coupled by the coupling portion 78 extending in the X-axis direction. In the housed state of the extension tray portion 50, the coupling portion 78 of the first extension tray 70 is covered by the second extension tray 60, but the two regions 71a and 71b of the upper surface 71 are exposed from the second extension tray 60.

A width of the extension tray housing portion 51 (recess) in the sheet discharge direction D is smaller than a length when the extension tray portion 50 is extended. The length when the extension tray portion 50 is extended is a length from an upstream end of the upper surface 71 (third surface) of the first extension tray 70 to a downstream end of the top surface 66a (fifth surface) of the rib 66 in the sheet discharge direction D when the first extension tray 70 is at the first use position and the second extension tray 60 is at the second use position.

In the housed state of the extension tray portion 50, the first contact portion 73 of the first extension tray 70 comes into contact with a first contacted portion 53 (FIG. 8A) of the extension tray housing portion 51, whereby the first extension tray 70 is held at the first retracted position. In the housed state of the extension tray portion 50, the rib 66 of the second extension tray 60 comes into contact with the coupling portion 78 of the first extension tray 70, whereby the second extension tray 60 is held at the second retracted position.

In the extended state of the extension tray portion 50 illustrated in FIGS. 7A and 7B, at least a part of the upper surface 71 (third surface) of the first extension tray 70 is positioned downstream of a discharge tray 12 (first surface) in the sheet discharge direction D and protrudes upward from the top surface 15 (second surface) of the front door 13. In the extended state of the extension tray portion 50, at least a part of the upper surface 71 (third surface) of the first extension tray 70 is inclined upward as it extends downstream in the sheet discharge direction D.

In the extended state of the extension tray portion 50, at least a part of the top surface 66a (fourth surface) of the rib 66 of the second extension tray 60 protrudes upward from the discharge tray 12 (first surface) and the upper surface 71 (third surface) of the first extension tray 70. In the extended state of the extension tray portion 50, at least a part of the top surface 66a (fourth surface) of the rib 66 of the second extension tray 60 is positioned downstream of the upper surface 71 (third surface) of the first extension tray 70 in the sheet discharge direction D. In the extended state of the extension tray portion 50, at least a part of the top surface 66a (fourth surface) of the rib 66 of the second extension tray 60 is inclined upward as it extends downstream in the sheet discharge direction D.

A user can pivot the second extension tray 60 from the second retracted position to the second use position by placing a finger on the groove portion 63 of the second extension tray 60 to change the extension tray portion 50 from the housed state to the extended state.

When the second extension tray 60 is pivoted from the second retracted position to the second use position, the first extension tray 70 is moved from the first retracted position to the first use position by the pressing rib 65 (interlocking portion) described below. When the first extension tray 70 moves from the first retracted position to the first use position, at least a part of the upper surface (third surface) of the first extension tray 70 moves upward.

Specifically, when the second extension tray 60 is pivoted toward the second use position, the pressing rib 65 of the second extension tray 60 presses the pressed portion 75 provided in the coupling portion 78 of the first extension tray 70 upward, so that the first extension tray 70 moves toward the first use position. That is, the first extension tray 70 includes the force receiving portion (pressed portion 75) disposed downstream of the pivot axis X1 (first pivot axis) in the sheet discharge direction D. The first extension tray 70 is configured to move from the first retracted position to the first use position when the force receiving portion receives an upward force from the interlocking portion (pressing rib 65).

The pivot axis X2 of the second extension tray 60 moves upward along with the movement of the first extension tray 70. Further, the second extension tray 60 is pivoted while sliding on a guide rib 54 of the extension tray housing portion 51 at the second contact portion 64. The pivoting of the second extension tray 60 is stopped when the second contact portion 64 abuts against an abutment portion 55 of the extension tray housing portion 51, and is held at the second use position by the abutment portion 55 (FIG. 7B).

In the present embodiment, the first extension tray 70 is pivotable around the pivot axis X1 with respect to the housing 1C, and the second extension tray 60 is pivotable around the pivot axis X2 with respect to the first extension tray 70. Therefore, in the extended state of the extension tray portion 50 (FIG. 7B), the second contact portion 64 of the second extension tray 60 is positioned by abutting against the abutment portion 55, whereby postures of both the first extension tray 70 and the second extension tray 60 are determined.

In the extended state of the extension tray portion 50, each of the upper surface 71 (third surface) of the first extension tray 70 and the top surface 66a (fourth surface) of the rib 66 of the second extension tray 60 forms an inclined surface capable of receiving a lower surface of the sheet S together with the discharge tray 12 (first surface). In the extended state of the extension tray portion 50, a discharge roller pair 11 can convey the sheet S to a position where the sheet S comes into contact with the upper surface 71 (third surface) of the first extension tray 70 and the top surface 66a (fourth surface) of the rib 66 of the second extension tray 60.

A position of at least a part of the upper surface 71 (third surface) in the direction of gravity when the first extension tray 70 is at the first use position (FIG. 7B) may preferably be higher than a position of the first face 61 (fifth surface) when the second extension tray 60 is at the second retracted position (FIG. 6B). That is, when the extension tray portion 50 in the housed state is extended, the upper surface 71 of the first extension tray 70 may preferably protrude to a position higher than the positions of the first face 61 of the second extension tray 60 and the upper surface 71 of the first extension tray 70, which form the upper surface of the extension tray portion 50 in the housed state.

In the second extension tray 60, the top surface 66a includes both end portions, and one of the both end portions is an end portion (tip end portion) 66a1 that is farther from the pivot axis X2 than the other of the both end portions is from the pivot axis X2. It may be preferable that the end portion 66a1 of the top surface 66a of the rib 66 on a side farther from the pivot axis X2 of the second extension tray 60 is pivoted so as to cross the pivot axis X2. That is, it may be preferable that, when the second extension tray 60 is at the second retracted position (FIG. 6B), the end portion 66a1 of the top surface 66a (fourth surface) of the rib 66 on the side farther from the pivot axis X2 is positioned upstream of the pivot axis X2 in the sheet discharge direction D. Further, it may be preferable that, when the second extension tray 60 is at the second use position (FIG. 7B), the end portion 66a1 of the top surface 66a (fourth surface) of the rib 66 is positioned downstream of the pivot axis X2 in the sheet discharge direction D.

It may be preferable that, when the second extension tray 60 is at the second retracted position, the end portion 66a1 of the top surface 66a (fourth surface) of the rib 66 is positioned upstream of a downstream end 71c of the upper surface 71 (third surface) of the first extension tray 70 in the sheet discharge direction D (FIGS. 6A and 6B).

It may be preferable that an inclination angle of the top surface 66a (fourth surface) of the rib 66 of the second extension tray 60 with respect to a horizontal plane in the extended state of the extension tray portion 50 is close to an inclination angle of an extension line 16 (FIG. 7B) of the discharge tray 12. It may be preferable that an inclination angle of the upper surface 71 (third surface) of the first extension tray 70 with respect to the horizontal plane in the extended state of the extension tray portion 50 is close to the inclination angle of the extension line 16 of the discharge tray 12.

### Summary of Present Embodiment

In the extended state of the extension tray portion 50, each of the upper surface 71 (third surface) of the first extension tray 70 and the top surface 66a (fourth surface) of the rib 66 of the second extension tray 60 forms the inclined surface. The sheet S conveyed toward the discharge tray 12 and the extension tray portion 50 by the discharge roller pair 11 comes into contact with the discharge tray 12 (first surface), the upper surface 71 (third surface) of the first extension tray 70, and the top surface 66a (fourth surface) of the rib 66 of the second extension tray 60. Then, the sheet S slides down upstream in the sheet discharge direction D according to the inclinations of the discharge tray 12 (first surface), the upper surface 71 (third surface) of the first extension tray 70, and the top surface 66a (fourth surface) of the rib 66 of the second extension tray 60.

Therefore, according to the present embodiment, it is possible to provide a sheet discharge apparatus and an image forming apparatus capable of improving alignment of discharged sheets.

According to the present embodiment, the pressing rib 65 (interlocking portion) moves the first extension tray 70 from the first retracted position to the first use position in conjunction with an operation of pivoting the second extension tray 60 from the second retracted position to the second use position. Therefore, both the first extension tray 70 and the second extension tray 60 can be moved from the retracted positions to the use positions by a simple operation of pivoting the second extension tray 60, so that usability can be improved.

Further, according to the present embodiment, even when the second extension tray 60 is pivoted between the second retracted position and the second use position, a variation in lower end position of the second extension tray 60 is suppressed. That is, a movement direction of the second contact portion 64, which is an end portion of the second extension tray 60 in a direction intersecting the pivot axis X2, is regulated in a direction along the guide rib 54. A change in relative position between the pivot axis X2 and the second contact portion 64 in the Z-axis direction is absorbed by the movement of the pivot axis X2 caused by the pivoting of the first extension tray 70.

In the first embodiment, the second extension tray 30 is pivotably supported by the housing 1C. In this case, the extension tray housing portion 21 of the housing 1C is provided with a space where the second contact portion 34 moves such that the end portion (second contact portion 34) of the second extension tray 30 does not interfere with the extension tray housing portion 21 when the second extension tray 30 is pivoted (FIG. 2B and FIG. 3B). On the other hand, in the present embodiment, since the variation in position of the end portion (second contact portion 64) of the second extension tray 60 when the second extension tray 60 is pivoted is suppressed, a size of the extension tray housing portion 51 in the Z-axis direction can be reduced, which is advantageous for miniaturizing the image forming apparatus 1 in the Z-axis direction.

### Other Modifications

A configuration for moving the first extension tray 40 in conjunction with the pivoting of the second extension tray 30 is not limited to those described in the first and second embodiments. For example, when the second extension tray 30 of the first embodiment is pivoted from the second retracted position to the second use position, the rib 36 may be configured to come into contact with a part of the first extension tray 40 to lift a downstream end of the first extension tray 40 in the sheet discharge direction D. In this case, a part of the top surface 36a (a part of the fourth surface) of the rib 36 functions as the interlocking portion.

In the above-described embodiment, each of the first surface, the second surface, the third surface, the fourth surface, and the fifth surface may be a top surface of a rib formed on a surface of a member, or may be a surface on which no rib is provided. For example, the first surface may be top surfaces of a plurality of ribs that are formed on the discharge tray 12, each extend in the sheet discharge direction D, and are arranged in the X-axis direction. Further, for example, the third surface may be a top surface of a rib formed on the upper surface 41 or 71 of the first extension tray 40 or 70. For example, the fifth surface may be a top surface of a rib formed on the first face 31 or 61 of the second extension tray 30 or 60.

Hitherto, in some cases, sheets discharged toward a sheet discharge tray and an extension tray cannot slide down along an inclination of the sheet discharge tray, as a result of which alignment of the sheets is deteriorated.

According to the present technology, it is possible to provide a sheet discharge apparatus and an image forming apparatus capable of improving alignment of discharged sheets.

### Other Embodiments

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-221171, filed Dec. 17, 2024, which is hereby incorporated by reference herein in its entirety.

What is claimed is:

1. A sheet discharge apparatus comprising:
a housing including an upper surface portion and a discharge opening through which a sheet discharged in a sheet discharge direction passes, the upper surface portion including a first surface that is inclined upward while extending downstream in the sheet discharge direction and a second surface that is provided downstream of the first surface in the sheet discharge direction, the first surface and the second surface being configured to receive the sheet discharged from the discharge opening, an angle between the second surface and a horizontal plane being smaller than an angle between the first surface and the horizontal plane;
a first extension tray including a third surface, disposed at the upper surface portion, and configured to move between a first retracted position and a first use position;
a second extension tray including a fourth surface and an interlocking portion, disposed at the upper surface portion, and configured to be pivoted between a second retracted position and a second use position, the interlocking portion being configured to move the first extension tray from the first retracted position to the first use position when the second extension tray is pivoted from the second retracted position to the second use position; and
a discharge roller configured to discharge the sheet through the discharge opening and convey the sheet to a position where the sheet comes into contact with the third surface and the fourth surface in a state in which the first extension tray is at the first use position and the second extension tray is at the second use position, wherein
in a state in which the first extension tray is at the first use position, at least a part of the third surface is positioned downstream of the first surface in the sheet discharge direction, is positioned above the second surface, and is inclined upward while extending downstream in the sheet discharge direction,
in a state in which the second extension tray is at the second use position, at least a part of the fourth surface is positioned downstream of the third surface in the sheet discharge direction, is positioned above the second surface and the third surface, and is inclined upward while extending downstream in the sheet discharge direction, and
at least a part of the third surface moves upward when the first extension tray moves from the first retracted position to the first use position.

2. The sheet discharge apparatus according to claim 1, wherein
the fourth surface faces downward in a state in which the second extension tray is at the second retracted position, and
the second extension tray includes a fifth surface configured to receive the sheet discharged by the discharge roller in a state in which the second extension tray is at the second retracted position.

3. The sheet discharge apparatus according to claim 2, wherein
a position of at least a part of the third surface in a direction of gravity in a case where the first extension tray is at the first use position is higher than a position of the fifth surface in a case where the second extension tray is at the second retracted position.

4. The sheet discharge apparatus according to claim 1, wherein
in a case where the second extension tray is at the second retracted position, an end portion of the fourth surface on a side farther from a pivot axis of the second extension tray is positioned upstream of the pivot axis in the sheet discharge direction, and
in a case where the second extension tray is at the second use position, the end portion of the fourth surface is positioned downstream of the pivot axis in the sheet discharge direction.

5. The sheet discharge apparatus according to claim 1, wherein
in a case where the second extension tray is at the second retracted position, an end portion of the fourth surface on a side farther from a pivot axis of the second extension tray is positioned upstream of a downstream end of the third surface in the sheet discharge direction.

6. The sheet discharge apparatus according to claim 1, wherein
the first extension tray is configured to be pivoted around a first pivot axis orthogonal to both the sheet discharge direction and a direction of gravity,
the second extension tray is configured to be pivoted around a second pivot axis that is parallel to the first pivot axis and is disposed downstream of the first pivot axis in the sheet discharge direction, and
the first extension tray includes a force receiving portion disposed downstream of the first pivot axis in the sheet discharge direction, and is configured to move from the first retracted position to the first use position in a case where the force receiving portion receives an upward force from the interlocking portion.

7. The sheet discharge apparatus according to claim 6, wherein
the second extension tray includes a plate portion extending in a pivot axis direction of the second extension tray, a first rib protruding in a direction intersecting the pivot axis direction from one end of the plate portion in the pivot axis direction, and a second rib protruding in the direction intersecting the pivot axis direction from another end of the plate portion in the pivot axis direction,
the fourth surface is a top surface of each of the first rib and the second rib, and
the interlocking portion is a rib that is disposed between the first rib and the second rib in the pivot axis direction and protrudes from the plate portion in the direction intersecting the pivot axis direction.

8. The sheet discharge apparatus according to claim 1, wherein
in a state in which the first extension tray is at the first retracted position and the second extension tray is at the second retracted position, the third surface is covered by the second extension tray as viewed in a direction of gravity.

9. The sheet discharge apparatus according to claim 8, wherein
each of the first extension tray and the second extension tray is pivotably supported by the housing.

10. The sheet discharge apparatus according to claim 1, wherein
in a state in which the first extension tray is at the first retracted position and the second extension tray is at the second retracted position, at least a part of the third surface is exposed to an outside of the second extension tray and is configured to receive the sheet discharged by the discharge roller.

11. The sheet discharge apparatus according to claim 10, wherein
the first extension tray is pivotably supported by the housing, and
the second extension tray is pivotably supported by the first extension tray.

12. The sheet discharge apparatus according to claim 1, wherein
the upper surface portion of the housing is formed with a recess that is recessed downward with respect to the second surface and is configured to accommodate the first extension tray at the first retracted position and the second extension tray at the second retracted position, and
a width of the recess in the sheet discharge direction is smaller than a length from an upstream end of the third surface to a downstream end of the fourth surface in the sheet discharge direction in a case where the first extension tray is at the first use position and the second extension tray is at the second use position.

13. The sheet discharge apparatus according to claim 12, wherein
the housing includes a body case provided with an opening portion configured to allow access to an inside of the housing, and an opening/closing member configured to move between a position where the opening portion is closed and a position where the opening portion is opened,
the first surface is provided in the body case, and
the second surface and the recess are provided in the opening/closing member.

14. The sheet discharge apparatus according to claim 1, wherein
the housing has a wall surface provided upstream of the first surface in the sheet discharge direction and below the discharge opening.

15. An image forming apparatus comprising:
the sheet discharge apparatus according to claim 1; and
an image forming unit that is accommodated in the housing and configured to form an image on a sheet,
wherein the discharge roller is configured to discharge the sheet on which the image has been formed by the image forming unit.
